(19) United States
(12) Patent Application Publication
(10) Pub. No.: US 2003/0072426 A1
(43) Pub. Date: Apr. 17, 2003

(54) Method for processing potentially unwanted calls

(76) Inventors: Richard Davidson, Casselberry, FL (US); Ronald McClain, Lake Mary, FL (US)

Correspondence Address: Siemens Corporation, Intellectual Property Department, 186 Wood Avenue South, Iselin, NJ, 08830, US

(21) Appl. No.: 09/964,147

(22) Filed: Sep. 26, 2001

(51) Int. Cl. H04M 1/56; H04M 15/06; H04M 3/42

(52) U.S. Cl. 379/142.01; 379/142.06; 379/211.01

(57) ABSTRACT

A method is provided for screening telemarketing, or other potentially unwanted, calls to jurisdictions where such calls may be made from only public telephone numbers. If such call is from a private telephone number and if the called party subscribes to and has activated a telemarketing-do-not-disturb feature, an announcement is issued to the calling party stating that if the call is a not a telemarketing call, the calling party must enter a designated override digit in order to complete the call. If such override digit is dialed, the call is completed whereas if any other digit, ringing of the called party's telephone is prevented. If, on the other hand, such call is from a public number, a determination is made as to whether the called party has a caller ID feature, and if not, the announcement is issued to the calling party. If the override digit is dialed, the call is completed whereas if any other digit is dialed, ringing of the called party's telephone is prevented. If, on the other hand, the call is determined to be from a public number, and if such called party has a caller ID feature; the called party's telephone is rung and the calling party's public telephone number ID is delivered to the called party.

### TECHNICAL FIELD

This invention relates generally to methods for processing potentially unwanted calls, such as telemarketing calls, and more particularly to methods for enabling called parties to prevent receipt of such calls.

### BACKGROUND

Methods are available to enable a called subscriber to simply block telephone calls made by an unidentified caller. To circumvent this, many telemarketers select unlisted numbers that prevent the called party from identifying the caller, for example with the caller-ID feature provided by may telephone companies. To further complicate this situation, residential customers may select to have an unlisted number to preserve the privacy of their number. This causes confusion at the called party's customer's end since the called party may actually wish to receive the telephone call from an unlisted friend but not from an unlisted marketer. Thus, the need exists to provide a well-functioning identification method for selecting and screening unwanted telemarketing calls.

As is known in the art, some telecommunication switches provide a Telemarketing Do Not Disturb (“T-DND”) feature. Subscription and use of this service causes the switch to block, indiscriminately, all calls from callers having unlisted telephone numbers. This is problematic with respect to the above-stated situation, in that residential users who request that their number be unlisted are blocked by the switch from completing their calls.

In response, many jurisdictions have passed legislation that requires telemarketers to identify themselves to the called parties that request such identification, and further, have made it a punishable offense to misrepresent the nature of the telephone call when required to identify themselves. Thus, a solution is needed in which a T-DND feature is subscribed to and activated by the called party that discriminates between the two types of unlisted callers and takes advantage of the above-mentioned legislation. Thus, for example, the telecommunications switch may issue an announcement to an unlisted calling party that requests the calling party to identify itself as a telemarketer by entering some digit, for example a “1”, in order to complete the call. Once the “1” is dialed. the call is completed. If any other digit is entered, as would be required for a telemarketer, the calling party (i.e., telemarketer) receives a busy tone. Such method is used in those individual states within the United States that allow telemarketers to use either public telephone numbers (i.e., telephone numbers which can be identified with caller ID equipment) or private telephone numbers (i.e., telephone numbers which cannot be identified with caller ID equipment).

### SUMMARY

In accordance with the present invention, a method is provided for screening a potentially unwanted call. If potentially unwanted calls may be made from only a public telephone number, the method determines whether the call is from a public telephone number or from a private telephone number. If such call is from a public telephone number, the method determines whether the called party has a caller ID feature, and if so, the method completes the call. If the calling party is either a private number or if the called party does not subscribe to caller ID, the method issues an announcement to the calling party stating that if the call is a potentially unwanted call (e.g., a telemarketing call), the calling party must enter a designated digit in order to complete the call and if such digit is dialed, the method completes the call. If on the other hand, any other digit is dialed, the method prevents ringing of the called party's telephone.

In accordance with another feature of the invention, if the potentially unwanted call may be made from only a public telephone number, the method determines whether the call is from a public telephone number or from a private telephone number. If such call is from a public number, a determination is made as to whether the called party has a caller ID feature. If the called party has a caller ID feature, the called party's telephone is rung and the calling party's ID is presented to the called party's telephone. If the calling party is not a public number (i.e., a private number) or if the called party does not have caller ID, an announcement is issued to the calling party stating that if the call is a potentially unwanted call, the calling party must enter a designated override digit in order to complete the call. If such override digit is dialed, the call is completed whereas if any other digit is dialed the ringing of the called party's telephone is prevented.

In accordance with another feature of the invention, a method is provided for screening a potentially unwanted call. If the potentially unwanted call may be made from only a public telephone number, a determination is made as to whether said call is from a public telephone number or from a private telephone number. If such call is from a private telephone number, an announcement is issued to the calling party stating that if the call is a potentially unwanted call, the calling party must enter a designated override digit in order to complete the call and if such override digit is dialed, the call is completed whereas if any other digit is dialed, ringing of the calling party's telephone is prevented, i.e., the call is not completed. If, on the other hand, such call is determined to be from a public number, a determination is made as to whether the called party has a caller ID feature, and if not, the announcement is issued to the calling party. If, on the other hand, such call is determined to be from a public number, and if such called party has a caller ID feature, the called party's telephone is rung and the call is delivered to the called party along with the calling party's public telephone number ID.

In one embodiment, a method is provided for screening telemarketing calls to jurisdictions where such calls may be made from only public telephone numbers. The method includes determining whether a call to such jurisdiction is from a public telephone number or from a private telephone number. If such call is determined to be from a private telephone number and if the called party subscribes to and has activated a telemarketing-do-not-disturb feature, an announcement is issued to the calling party stating that if the call is a not a telemarketing call, the calling party must enter a designated override digit in order to complete the call. If such override digit is dialed, the call is completed whereas if any other digit, ringing of the calling party's telephone is prevented, i.e., the call is not completed. If, on the other hand, such call is determined to be from a public number, a determination is made as to whether the called party has a caller ID feature, and if not the announcement is issued. If, on the other hand, the call is determined to be from a public number, and if such called party has a caller ID feature; the called party's telephone is rung and the calling party's public telephone number ID is delivered to the called party.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a public switching telephone network with a central office thereof adapted to perform a method for processing potentially unwanted calls according to the invention; and

FIG. 2 is a flow diagram of the step used by the central office in FIG. 1 for processing the potentially unwanted calls according to the invention.

### DETAILED DESCRIPTION

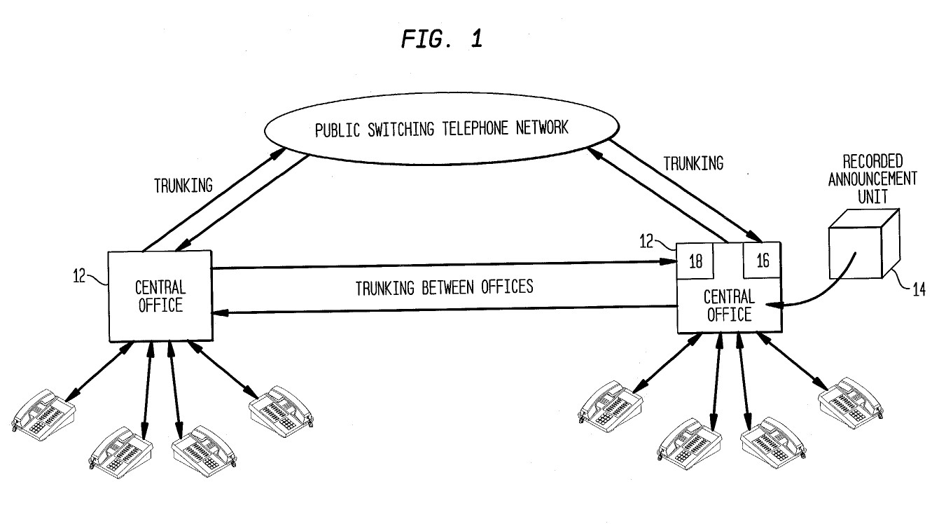

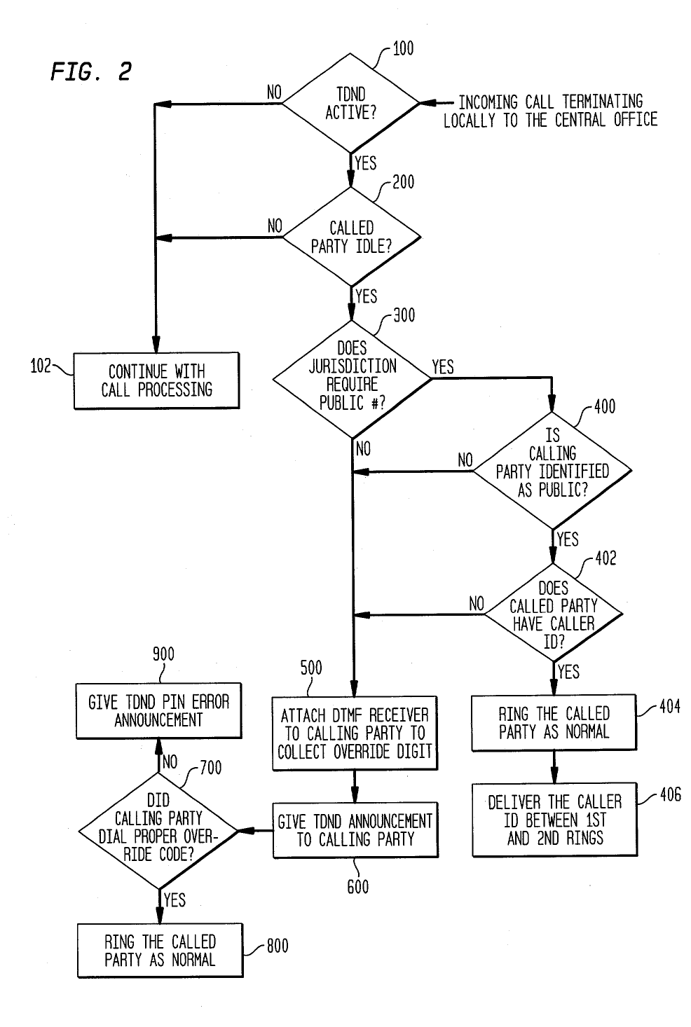

Referring now to FIG. 1, a public switching telephone network 10 is shown with a central office 12 thereof adapted to perform a method for processing potentially unwanted calls. The central office 12 has a recorded announcement unit 14, and a data base 16 which stored features subscribed to by subscribers connected to such central office. The central office also stores a computer program 18 for execution the step used by the central office 12 in processing the potentially unwanted calls according to the invention, such steps being shown by the flow diagram in FIG. 2.

Thus, referring to FIG. 2, consider an incoming call terminating locally at the central office 12. The computer program 18 determines by examining the database 16 whether any telemarketing do-not-disturb (T-DND) feature has been activated by the called party. For example, the T-DND feature may be activated by a subscriber to such feature by dialing *78 and may be de-activated by dialing *79. If the database 16 indicates (Step 100) that the called party does not subscribe the T-DND feature, or indicates that the called party does subscribe to such feature but that such feature has been deactivated by the called party at the time the incoming call is terminated, the call processing continues (Step 102) such as by merely ringing the called party's telephone or forwarding the call to some other telephone, if the called party subscribes to a call-forwarding feature, for example.

On the other hand, if the called party subscribes to T-DND, and the T-DND is activated at the time the call is terminated, the central office determines 10 whether the called party's telephone is busy (Step 200). If the phone is busy, the call processing is continued (Step 102) and for example, a busy signal is sent to the calling party. If, on the other hand, the called party's telephone is not busy (Step 200), a determination is made at the central office (Step 300) as to whether the jurisdiction, e.g. state, requires that telemarketers made calls from only public telephone numbers.

If the jurisdiction requires that telemarketing calls to such jurisdiction may be made from only a public telephone number (Step 300), a determination is made (Step 400) as to whether the incoming call is from a public telephone number or from a private telephone number. If such call is determined in Step 400 to be from a private telephone number, the central office attaches a DTMF receiver to the calling party to collect an override digit to be described (Step 500). Next, the recorded announcement unit 14 issues (Step 600) an announcement to the calling party stating that if the call is a not a telemarketing call, the calling party must enter a designated digit (i.e., the aforementioned override digit), for example 1, in order to complete the call. If such override digit is dialed (Step 700), the call is completed (Step 800) and the called party's telephone is rung. If, on the other hand, Step 700 determines that the override digit has not been entered, a T-DND error message is sent or a busy tone is generated and sent to the calling party, or the call is otherwise prevented for ringing the called party's telephone. (Step 900).

If in Step 400, however, the incoming call is determined to be from a public number, a determination is made in Step 402 as to whether the called party has a caller ID feature. If not, the call is processed as described above with respect to Steps 500, 600, 700, 800 or 900. If, however, the central office determines in Step 402 that the called party subscribes to caller ID, the central office 12 processes the telephone call normally by ringing the called party's telephone (Step 404) and delivering is the calling party's public telephone number ID to the called party (Step 406).

A number of embodiments of the invention have been described. Nevertheless, it will be understood that various modifications may be made without departing from the spirit and scope of the invention. Accordingly, other embodiments are within the scope of the following claims.

What is claimed is:

1. A method for screening a potentially unwanted call, comprising:
if the potentially unwanted call may be made from only a public telephone number, determining whether said call is from a public telephone number or from a private telephone number;
if such call is from a public number, determining whether the called party has a caller ID feature, and if so, completing the call, whereas if the calling part is a private number or if the called party does not subscribe to caller ID, issuing an announcement to the calling party stating that if the call is a potentially unwanted call, the calling party must enter a designated digit in order to complete the call and if such digit is dialed, completing the call whereas if any other digit is dialed preventing ringing of the called party's telephone.

2. A method for screening a potentially unwanted call, comprising:
if the potentially unwanted call may be made from only a public telephone number, determining whether said call is from a public telephone number or from a private telephone number;
if such call is from a public number, determining whether the called party has a caller ID feature, and if so, completing the call, and if not, issuing an announcement to the calling party stating that if the call is a potentially unwanted call, the calling party must enter a designated digit in order to complete the call and if such digit is dialed, completing the call whereas if any other digit is dialed preventing ringing of the called party's telephone.

3. A method for screening a potentially unwanted call, comprising:
if the potentially unwanted call may be made from only a public telephone number, determining whether said call is from a public telephone number or from a private telephone number;
if such call is determined to be from a private telephone number, issuing an announcement to the calling party stating that if the call is a potentially unwanted call, the calling party must enter a designated digit in order to complete the call and if such digit is dialed, completing the call whereas if any other digit is dialed preventing ringing of the called party's telephone; and
if such call is determined to be from a public number, determining whether the called party has a caller ID feature, and if not, issuing the announcement to the calling party and if such digit is dialed, completing the call whereas if the announcement is issued and any other digit is dialed, preventing ringing of the called party's telephone; and
if such call is determined to be from a public number, and if such called party has a caller ID feature, ringing the called party's telephone and delivering to the called party the calling party's public telephone number ID.

4. A method for screening telemarketing calls to jurisdictions where such calls may be made from only public telephone numbers, comprising:
if a called party subscribes to and has activated a telemarketing-do-not-disturb feature, issuing an announcement to the calling party stating that if the call is a not a telemarketing call, the calling party must enter a designated digit in order to complete the call and if such digit is dialed, completing the call whereas if any other digit is dialed preventing ringing of the called party's telephone; and
if such call from a public number, determining whether the called party has a caller ID feature, and if not, issuing the announcement to the calling party and if such digit is dialed, completing the call whereas if any other digit is dialed preventing ringing of the called party's telephone; and
if such call is from a public number, and if such called party has a caller ID feature; ringing the called party's telephone and delivering to the called party the calling party's public telephone number ID.

5. A method for screening a solicitation telephone call on a telephone network, comprising:
determining if a jurisdiction of a called party requires solicitor's telephone calls to be identifiable by the called party;
determining if a calling party is using a public telephone number if said jurisdiction requires solicitor's telephone calls to be identifiable;
determining if said called party has a caller ID feature if said called party is using a public telephone number; and
completing said call where either
(a) said jurisdiction requires solicitor's telephone calls to be identifiable, said called party is using a public telephone number and said called party has a caller ID feature; or
(b) said calling party provides an override digit in response to an announcement provided by said telephone network that identifies said calling party as a solicitor on said caller ID feature of said called party.

6. The method of claim 5 further comprising delivering an identifier for said calling party to said caller ID feature when said call is completed.

7. The method of claim 5 further comprising issuing a busy tone from said network to said calling party to said caller ID feature when said call is completed.

8 A method for screening a potentially unwanted call, comprising:
determining whether the jurisdiction where such call is made to may be made from only a public telephone number;
if it is determined that the potentially unwanted call may be made from only a public telephone number, determining whether said call is from a public telephone number or from a private telephone number;
if such call is determined to be from a public number, determining whether the called party has a caller ID feature, and if so, completing the call, whereas if the calling part is a private number or if the called party does not subscribe to caller ID, issuing an announcement to the calling party stating that if the call is a potentially unwanted call, the calling party must enter a designated digit in order to complete the call and if such digit is dialed, completing the call whereas if any other digit is dialed preventing ringing of the called party's telephone.

9 A method for screening a potentially unwanted call, comprising:
determining whether the jurisdiction where such call is made to may be made from only a public telephone number;
if it is determined that the potentially unwanted call may be made from only a public telephone number, determining whether said call is from a public telephone number or from a private telephone number;
if such call is determined to be from a public number, determining whether the called party has a caller ID feature, and if so, completing the call, and if not, issuing an announcement to the calling party stating that if the call is a potentially unwanted call, the calling party must enter a designated digit in order to complete the call and if such digit is dialed, completing the call whereas if any other digit is dialed preventing ringing of the called party's telephone.

10 A method for screening a potentially unwanted call, comprising:
determining whether the jurisdiction where such call is made to may be made from only a public telephone number;
if it is determined that the potentially unwanted call may be made from only a public telephone number, determining whether said call is from a public telephone number or from a private telephone number;
if such call is determined to be from a private telephone number, issuing an announcement to the calling party stating that if the call is a potentially unwanted call, the calling party must enter a designated digit in order to complete the call and if such digit is dialed, completing the call whereas if any other digit is dialed preventing ringing of the called party's telephone; and
if such call is determined to be from a public number, determining whether the called party has a caller ID feature, and if not, issuing the announcement to the calling party and if such digit is dialed, completing the call whereas if the announcement is issued and any other digit is dialed, preventing ringing of the called party's telephone; and
if such call is determined to be from a public number, and if such called party has a caller ID feature, ringing the called party's telephone and delivering to the called party the calling party's public telephone number ID.

11 A method for screening telemarketing calls to jurisdictions where such calls may be made from only public telephone numbers, comprising:
determining whether a call to such jurisdiction is from a public telephone number or from a private telephone number;
if such call is determined to be from a private telephone number, if the called party subscribes to and has activated a telemarketing-do-not-disturb feature, issuing an announcement to the calling party stating that if the call is a not a telemarketing call, the calling party must enter a designated digit in order to complete the call and if such digit is dialed, completing the call whereas if any other digit is dialed preventing ringing of the called party's telephone; and
if such call is determined to be from a public number, determining whether the called party has a caller ID feature, and if not, issuing the announcement to the calling party and if such digit is dialed, completing the call whereas if any other digit is dialed preventing ringing of the called party's telephone; and
if such call is determined to be from a public number, and if such called party has a caller ID feature; ringing the called party's telephone and delivering to the called party the calling party's public telephone number ID.
